(19) United States
(12) Patent Application Publication
(10) Pub. No.: US 2005/0090207 A1
(43) Pub. Date: Apr. 28, 2005

(54) Diversity reception tuner

(75) Inventor: Koji Oiwa, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 10/969,009

(22) Filed: Oct. 21, 2004

(30) Foreign Application Priority Data
Oct. 24, 2003 (JP) 2003-364979

(51) Int. Cl. H04B 1/10; H04B 7/02

(52) U.S. Cl. 455/101

(57) ABSTRACT

A diversity reception tuner of the invention has one first tuner and at least one tuner. The first tuner has a first PLL circuit and a first voltage-controlled oscillation circuit controlled by a tuning voltage generated by the first PLL circuit, and performs frequency conversion on a desired reception signal by using a local oscillation signal outputted from the first voltage-controlled oscillation circuit. The tuner performs frequency conversion on the desired reception signal by using the local oscillation signal outputted from the first voltage-controlled oscillation circuit. With this configuration, an inexpensive diversity reception tuner is realized that can always use the reception signal from whichever antenna offers optimum reception at the moment.

This nonprovisional application claims priority under 35 U.S.C. § 119(a) on Patent Application No. 2003-364979 filed in Japan on Oct. 24, 2003, the entire contents of which are hereby incorporated by reference.

### BACKGROUND OF THE INVENTION

1. Field of the Invention

The present invention relates to a tuner for diversity reception.

2. Description of Related Art

As an example of a conventional tuner, a tuner for selecting one among a number of signals transmitted from different TV broadcast stations to receive a desire program will be described. An example of the configuration of a conventional tuner is shown in FIG. 5. The tuner 1 shown in FIG. 5 includes an RF input terminal 1a, a band-pass filter (BPF) 1b, an RF amplifier 1c, a band-pass filter (BPF) 1d, a PLL circuit 1e, a voltage-controlled oscillation circuit (VCO) 1f, a mixer circuit 1g, and an IF output terminal 1h. An antenna 3 is connected to the RF input terminal 1a, and the IF output terminal 1h is connected to a demodulation circuit 4.

A number of reception signals are received by the antenna 3, and are fed to the RF input terminal 1a. Of these reception signals, only the one that the user desires to receive is selected by the band-pass filter 1b, of which the filtering characteristic varies according to a tuning voltage generated by the PLL circuit 1e. The desired reception signal selected by the band-pass filter 1b is then amplified by the RF amplifier 1c.

Thereafter, of the signals outputted from the RF amplifier 1c, the one that the user desires to receive is further selected by the band-pass filter 1d, of which the filtering characteristic varies according to the tuning voltage generated by the PLL circuit 1e. The thus selected reception signal is fed to the mixer circuit 1g. The mixer circuit 1g also receives a local oscillation signal oscillated by the voltage-controlled oscillation circuit 1f. Here, the frequency of the local oscillation signal varies according to the tuning voltage generated by the PLL circuit 1e.

The mixer circuit 1g performs frequency conversion by mixing together the desired reception signal and the local oscillation signal, with the result that the desired reception signal is down-converted into an intermediate-frequency (IF) signal, which is then outputted to the IF output terminal 1h. The frequency of the intermediate-frequency signal is determined by the difference between the frequency of the local oscillation signal and the frequency of the desired reception signal. The PLL circuit 1e generates different tuning voltages for different desired reception channels. Accordingly, the frequency of the local oscillation signal is varied in proportion to the frequency of the desired reception signal, so that the intermediate-frequency signal outputted from the mixer circuit 1g always has a constant frequency.

The intermediate-frequency signal fed from the IF output terminal 1h to the demodulation circuit 4 is demodulated by the demodulation circuit 4. For example, in a case where a digital TV broadcast is received, used as the demodulation circuit 4 is a demodulation circuit that performs digital demodulation on the intermediate-frequency signal to obtain a digital signal such as a transport stream. By contrast, in a case where an analog TV broadcast is received, used as the demodulation circuit 4 is a demodulation circuit that performs analog demodulation on the intermediate-frequency signal to obtain an analog signal such as a video signal and an audio signal.

In car-mounted televisions, portable televisions, portable radios, mobile telephones, and the like, changing the position and orientation of their antenna often causes remarkable change in reception condition. For this reason, in car-mounted televisions, portable televisions, portable radios, mobile telephones, and the like, it is common to use, instead of the reception apparatus shown in FIG. 5, a reception apparatus (diversity reception apparatus) that uses a plurality of antennas so as to cope with change in reception condition by choosing whichever of the antennas offers optimum reception at the moment.

An example of the configuration of a conventional diversity reception tuner is shown in FIG. 6. In FIG. 6, such circuit blocks as are found also in FIG. 5 are identified with the same reference numerals, and their detailed explanations will not be repeated. This conventional diversity reception tuner 100 is provided with a first tuner 1 and a second tuner 2.

The second tuner 2 has the same configuration as the first tuner 1. Specifically, the second tuner 2 includes an RF input terminal 2a, a band-pass filter (BPF) 2b, an RF amplifier 2c, a band-pass filter (BPF) 2d, a PLL circuit 2e, a voltage-controlled oscillation circuit (VCO) 2f, a mixer circuit 2g, and an IF output terminal 2h, and these are respectively the same components as the RF input terminal 1a, the band-pass filter (BPF) 1b, the RF amplifier 1c, the band-pass filter (BPF) 1d, the PLL circuit 1e, the voltage-controlled oscillation circuit (VCO) 1f, the mixer circuit 1g, and the IF output terminal 1h.

The RF input terminal 1a of the first tuner 1 is connected to an antenna 3, and the RF input terminal 2a of the second tuner 2 is connected to an antenna 5. The IF output terminal 1h of the first tuner 1 is connected to a demodulation circuit 4, and the IF output terminal 2h of the second tuner 2 is connected to a demodulation circuit 6. A comparator 7 compares the demodulated signals outputted respectively from the demodulation circuits 4 and 6 to select and output whichever of those signals has higher quality (specifically, where the demodulated signals are analog signals, whichever has a higher S/N ratio; where the demodulated signals are digital signals, whichever has a lower bit error rate).

In the conventional diversity reception tuner 100, the first and second tuners 1 and 2 select the same broadcast. That is, the PLL circuits 1e and 2e generate the same tuning voltage, and the voltage-controlled oscillation circuits 1f and 2f oscillate the same local oscillation signal. Accordingly, quite naturally, the demodulated signals outputted respectively from the demodulation circuits 4 and 6 have the same contents.

For example, when the reception condition with the antenna 3 deteriorates, the quality of the demodulated signal obtained by processing the signal received by the antenna 3 deteriorates accordingly. Even then, so long as the reception condition with the antenna 5 is safe from deterioration, the quality of the demodulated signal obtained by processing the signal received by the antenna 5 is good. Thus, the comparator 7 discards the demodulated signal obtained by processing the signal received by the antenna 3, and chooses the demodulated signal obtained by processing the signal received by the antenna 5. In this way, it is possible to keep good the quality of the demodulated signal obtained in the reception apparatus as a whole.

As described above, diversity reception is a reception method that prevents deterioration of the reception condition in a reception apparatus as a whole even when the reception condition with part of a plurality of antennas deteriorates so long as the reception condition with at least one of those antennas is good.

The conventional diversity reception tuner 100 shown in FIG. 6 is provided with two tuners. This makes the tuner 100 more expensive to produce than the conventional tuner 1 shown in FIG. 5. In diversity reception, the greater the number of antennas used, the better the reception condition obtained. Increasing the number of antennas, however, necessitates the provision of as many tuners, and therefore the greater the number of antennas, the more expensive to produce a tuner becomes.

On the other hand, Japanese Patent Application Laid-Open No. H10-84297 discloses a diversity reception tuner that is provided with a single tuner in combination with a switch for controlling the interconnection between the tuner and a plurality of antennas. This configuration makes the tuner less expensive to produce than the conventional diversity reception tuner 100 shown in FIG. 6. In this diversity reception tuner disclosed in Japanese Patent Application Laid-Open No. H10-84297, however, the reception condition with the different antennas cannot be compared simultaneously. Disadvantageously, this makes it difficult to always use whichever of the antennas offers optimum reception at the moment.

### SUMMARY OF THE INVENTION

An object of the present invention is to provide an inexpensive diversity reception tuner that can always use the reception signal from whichever antenna offers optimum reception at the moment, and to provide a reception apparatus and an electric appliance provided with such a diversity reception tuner.

To achieve the above object, in one aspect of the present invention, a diversity reception tuner is provided with one first tuner and at least one tuner. The first tuner has a first PLL circuit and a first voltage-controlled oscillation circuit controlled by a tuning voltage generated by the first PLL circuit, and performs frequency conversion on a desired reception signal by using a local oscillation signal outputted from the first voltage-controlled oscillation circuit. The tuner performs frequency conversion on the desired reception signal by using the local oscillation signal outputted from the first voltage-controlled oscillation circuit.

To achieve the above object, in another aspect of the present invention, a diversity reception tuner is provided with one first tuner and at least one tuner. The first tuner has a first PLL circuit and a first voltage-controlled oscillation circuit controlled by a tuning voltage generated by the first PLL circuit, and performs frequency conversion on a desired reception signal by using a local oscillation signal outputted from the first voltage-controlled oscillation circuit. The tuner has a voltage-controlled oscillation circuit controlled by the tuning voltage generated by the first PLL circuit, and performs frequency conversion on the desired reception signal by using a local oscillation signal outputted from the voltage-controlled oscillation circuit.

To achieve the above object, in another aspect of the present invention, a diversity reception apparatus is provided with one of the diversity reception tuners configured as described above.

To achieve the above object, in another aspect of the present invention, an electric appliance is provided with the diversity reception apparatus configured as described above.

### BRIEF DESCRIPTION OF THE DRAWINGS

FIG. 1 is a diagram showing the configuration of the diversity reception tuner of a first embodiment of the invention;

FIG. 2A is a diagram showing the configuration of the diversity reception tuner of a second embodiment of the invention;

FIG. 2B is a diagram showing a modified example of the diversity reception tuner of FIG. 2A;

FIG. 3 is a diagram showing the configuration of the diversity reception tuner of a third embodiment of the invention;

FIG. 4 is a diagram showing the configuration of the diversity reception tuner of a fourth embodiment of the invention;

FIG. 5 is a diagram showing an example of the configuration of a conventional tuner; and

FIG. 6 is a diagram showing an example of the configuration of a conventional diversity reception tuner.

### DETAILED DESCRIPTION OF PREFERRED EMBODIMENTS

Hereinafter, as examples of diversity reception tuners according to the present invention, tuners for selecting one among a number of signals transmitted from different TV broadcast stations to receive a desire program will be described.

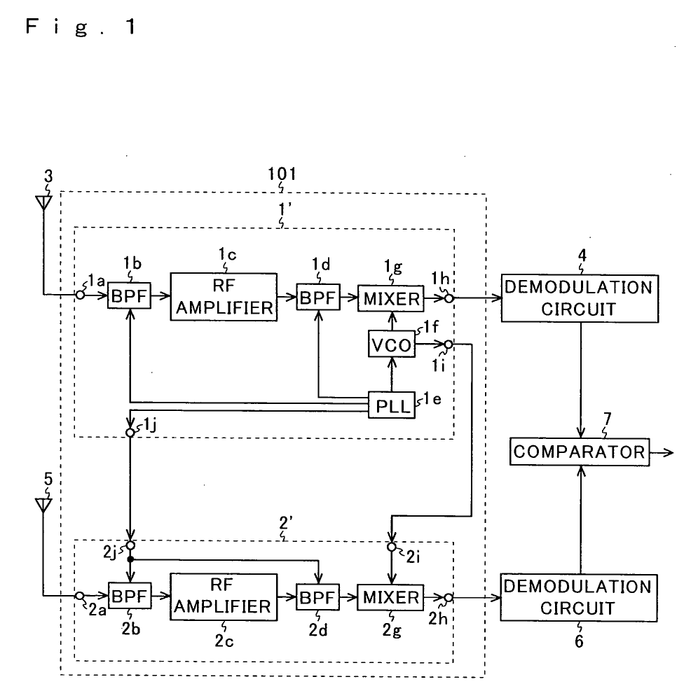

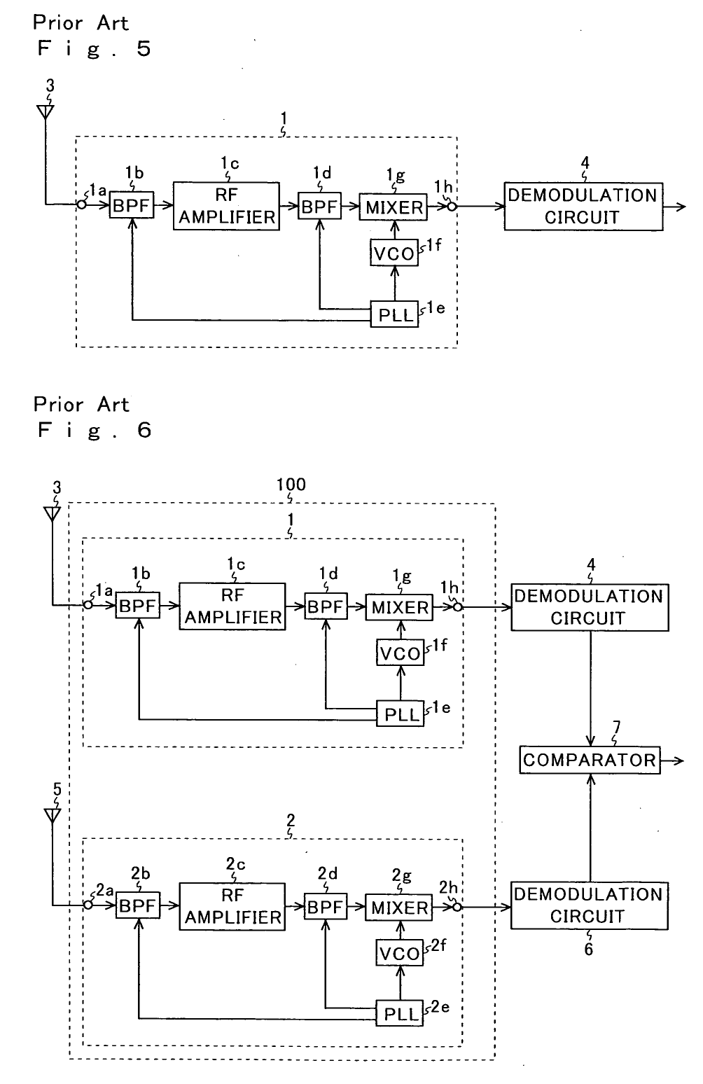

First, a description will be given of the diversity reception tuner of a first embodiment of the invention. The configuration of the diversity reception tuner of the first embodiment of the invention is shown in FIG. 1. In FIG. 1, such circuit blocks as are found also in FIG. 6 are identified with the same reference numerals, and their detailed explanations will not be repeated.

The diversity reception tuner 101 of the first embodiment of the invention is provided with a first tuner 1′ and a second tuner 2′.

The first tuner 1′ here, as compared with the first tuner 1 included in the conventional diversity reception tuner 100 shown in FIG. 6, further includes a local oscillation signal output terminal 1i and a tuning voltage output terminal 1j. The signal received by the antenna 3 is processed to produce an intermediate-frequency signal, which is outputted to the demodulation circuit 4. Moreover, the local oscillation signal oscillated by the voltage-controlled oscillation circuit 1f is outputted via the local oscillation signal output terminal 1i to the second tuner 2′, and the tuning voltage generated by the PLL circuit 1e is outputted via the tuning voltage output terminal 1j to the second tuner 2′. Furthermore, the first tuner 1′ is enclosed in a chassis so as to be electrically shielded.

The second tuner 2′ here, as compared with the second tuner 2 included in the conventional diversity reception tuner 100 shown in FIG. 6, lacks the PLL circuit 2e and the voltage-controlled oscillation circuit 2f, but instead includes a local oscillation signal input terminal 2i and a tuning voltage input terminal 2j. The local oscillation signal outputted from the first tuner 1′ is fed via the local oscillation signal input terminal 2i to the mixer circuit 2g, and the tuning voltage outputted from the first tuner 1′ is fed via the tuning voltage input terminal 2j to the band-pass filter 2b and the band-pass filter 2d.

The RF input terminal 1a of the first tuner 1′ is connected to the antenna 3, and the RF input terminal 2a of the second tuner 2′ is connected to the antenna 5. The IF output terminal 1h of the first tuner 1′ is connected to the demodulation circuit 4, and the IF output terminal 2h of the second tuner 2′ is connected to the demodulation circuit 6. The comparator 7 compares the demodulated signals outputted respectively from the demodulation circuits 4 and 6 to select and output whichever of those signals has higher quality (specifically, where the demodulated signals are analog signals, whichever has a higher S/N ratio; where the demodulated signals are digital signals, whichever has a lower bit error rate).

With this configuration, the local oscillation signals in the first and second tuners 1′ and 2′ are the same, so that the first and second tuners 1′ and 2′ select the same broadcast. This permits diversity reception. Moreover, in the diversity reception tuner 101 of the first embodiment of the invention, a PLL circuit and a voltage-controlled oscillation circuit, which are among the most expensive of all the components of the tuner, are provided only in the first tuner 1′. This configuration is less expensive to produce than one in which each tuner is provided with a PLL circuit and a voltage-controlled oscillation circuit. Moreover, since the tuners are provided one for each of a plurality of antennas, it is possible to always use the reception signal from whichever antenna offers optimum reception condition.

Moreover, with this configuration, the tuning voltages in the first and second tuners 1′ and 2′ are the same, so that there arise less differences in characteristics between the band-pass filters 1b and 2b and between the band-pass filters 1d and 2d, resulting in less differences in characteristics between the first and second tuners 1′ and 2′. In addition, the first and second tuners 1′ and 2′ require the same length of time to select a station. When the first and second tuners 1′ and 2′ require the same length of time to select a station, it is not necessary to check, when a station is selected, the status of the first and second tuners 1′ and 2′ one after the other. This permits the selection of the station to be completed in a shorter period of time.

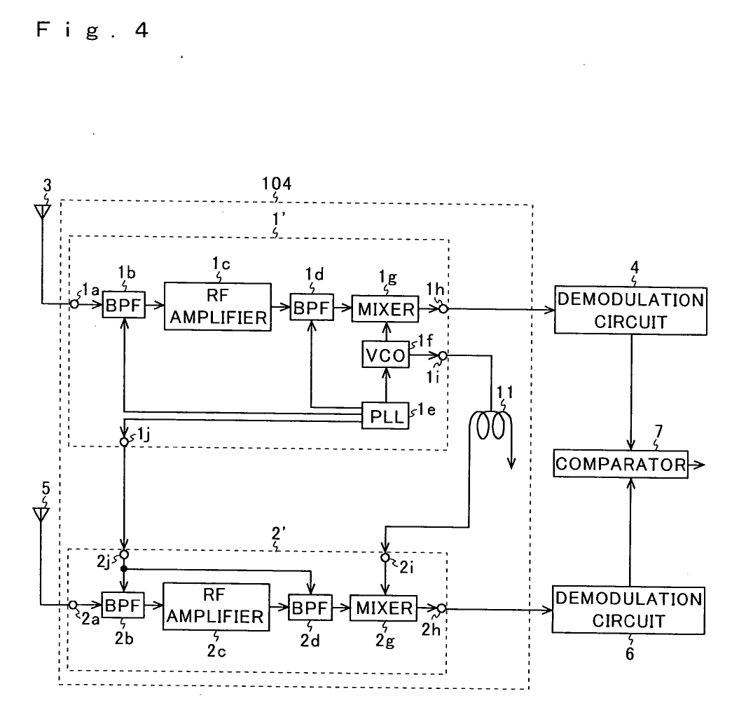

Moreover, since the first and second tuners 1′ and 2′ handle the same desired reception signal, satisfactory performance can be obtained even when each tuner is not enclosed in a chassis so as to be electrically shielded. To minimize the interference between the tuners, however, it is preferable to enclose each tuner in a chassis so as to electrically shield it. When the first tuner 1′ is enclosed in a chassis so as to be electrically shielded and is additionally provided with the local oscillation signal output terminal 1i and the tuning voltage output terminal 1j, it can then be used either as part of a diversity reception tuner according to the invention or, where diversity reception is not used, as a tuner on its own. That is, it is not necessary to produce as the first tuner 1′ one specially designed for diversity reception, but it suffices to slightly modify the conventional tuner 1 (see FIG. 5) to obtain a versatile tuner that can be used either as part of a diversity reception tuner according to the invention or as a tuner on its own. This brings enhanced design efficiency and other benefits.

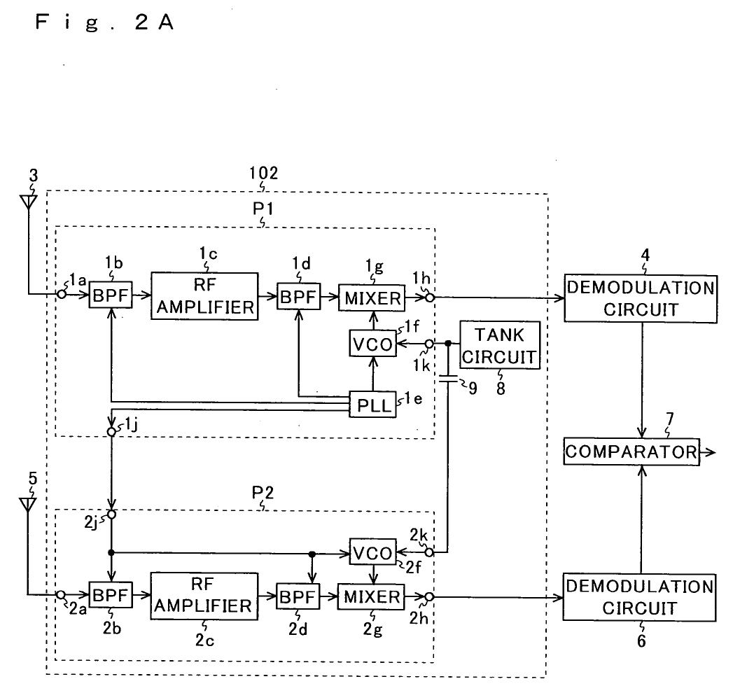

Next, a description will be given of the diversity reception tuner of a second embodiment of the invention. The configuration of the diversity reception tuner of the second embodiment of the invention is shown in FIG. 2A. In FIG. 2A, and also in FIG. 2B, which will be described later, such circuit blocks as are found also in FIG. 1 are identified with the same reference numerals, and their detailed explanations will not be repeated.

In recent years, developments in the technology of forming high-frequency circuits as integrated circuits have been making quite common IC chips that have a mixer circuit, a PLL circuit, and a voltage-controlled oscillation circuit integrated together and IC chips that have a mixer circuit and a voltage-controlled oscillation circuit integrated together. The diversity reception tuner 102 of the second embodiment of the invention includes those two types of IC chip, one each, and in addition a tank circuit 8 and a capacitor 9.

The diversity reception tuner 102 of the second embodiment of the invention is provided with a first tuner IC chip P1. This is an IC chip having a mixer circuit 1g, a PLL circuit 1e, and a voltage-controlled oscillation circuit 1f integrated together, and has a tank circuit connection terminal 1k. The diversity reception tuner 102 of the second embodiment of the invention is further provided with a second tuner IC chip P2. This is an IC chip having a mixer circuit 2g and a voltage-controlled oscillation circuit 2f integrated together, and has a tank circuit connection terminal 2k.

The tank circuit 8 is composed of a coil, a variable-capacitance element (typically a diode), and a capacitor, and serves to determine the tuning frequency of the voltage-controlled oscillation circuit.

The tank circuit connection terminal 1k is connected directly to the tank circuit 8, and the tank circuit connection terminal 2k is loose-coupled with the tank circuit 8 through the small-capacitance capacitor 9. Instead of the capacitor 9, any other element may be used that loose-couples the tank circuit connection terminal 2k with the tank circuit 8. Alternatively, the tank circuit connection terminal 1k may be loose-coupled with the tank circuit 8, with the tank circuit connection terminal 2k connected directly to the tank circuit 8.

With this configuration, the local oscillation signals in the first and second tuners have the same oscillation frequency, so that the first and second tuners select the same broadcast. This permits diversity reception. Moreover, in the diversity reception tuner 102 of the second embodiment of the invention, a PLL circuit, which is among the most expensive of all the components of the tuner, is provided only in the first tuner. This configuration is less expensive to produce than one in which each tuner is provided with a PLL circuit. Moreover, since the tuners are provided one for each of a plurality of antennas, it is possible to always use the reception signal from whichever antenna offers optimum reception condition.

Moreover, with this configuration, the tuning voltages in the first and second tuners are the same, so that there arise less differences in characteristics between the band-pass filters 1b and 2b and between the band-pass filters 1d and 2d, resulting in less differences in characteristics between the first and second tuners. In addition, the first and second tuners require the same length of time to select a station. When the first and second tuners require the same length of time to select a station, it is not necessary to check, when a station is selected, the status of the first and second tuners one after the other. This permits the selection of the station to be completed in a shorter period of time.

Moreover, since the first and second tuners handle the same desired reception signal, satisfactory performance can be obtained even when each tuner is not enclosed in a chassis so as to be electrically shielded. To minimize the interference between the tuners, however, it is preferable to enclose each tuner in a chassis so as to electrically shield it. When the first tuner is enclosed in a chassis so as to be electrically shielded and is additionally provided with the local oscillation signal output terminal 1i and the tank circuit connection terminal 1k, it can then be used either as part of a diversity reception tuner according to the invention or, where diversity reception is not used, as a tuner on its own. That is, it is not necessary to produce as the first tuner one specially designed for diversity reception, but it suffices to slightly modify the conventional tuner 1 (see FIG. 5) to obtain a versatile tuner that can be used either as part of a diversity reception tuner according to the invention or as a tuner on its own. This brings enhanced design efficiency and other benefits.

Furthermore, the diversity reception tuner 102 of the second embodiment of the invention uses common IC chips. This helps realize a less expensive and more versatile circuit configuration. Moreover, instead of providing a tank circuit for each voltage-controlled oscillation circuit, the single tank circuit 8 is shared between the voltage-controlled oscillation circuits 1f and 2f. This helps reduce the number of components, and thus helps realize a more inexpensive circuit configuration.

In a case where an IC chip that includes neither a PLL circuit nor a voltage-controlled oscillation circuit is used, a circuit configuration as shown in FIG. 2B may be adopted to build a diversity reception tuner 102′.

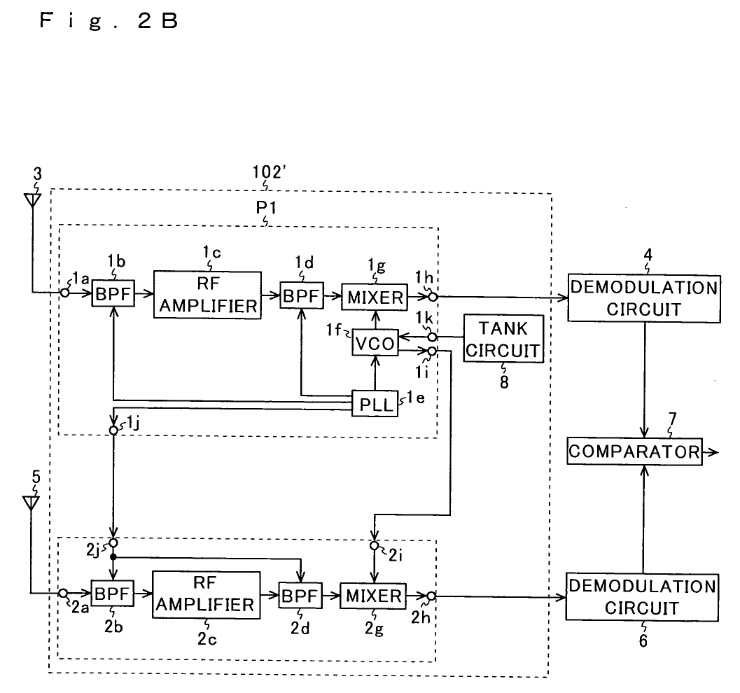

Next, a description will be given of the diversity reception tuner of a third embodiment of the invention. The configuration of the diversity reception tuner of the third embodiment of the invention is shown in FIG. 3. In FIG. 3, such circuit blocks as are found also in FIG. 1 are identified with the same reference numerals, and their detailed explanations will not be repeated.

The diversity reception tuner 103 of the third embodiment of the invention, as compared with the diversity reception tuner 100 of the first embodiment of the invention shown in FIG. 1, further includes a buffer amplifier 10. The input side of the buffer amplifier 10 is connected to the local oscillation signal output terminal 1i, and the output side of the buffer amplifier 10 is connected to the local oscillation signal input terminal 2i.

With this configuration, it is possible to suppress the leakage of the intermediate-frequency signal and other signals from the second tuner 2′ to the first tuner 1′. Moreover, it is also possible to minimize the deterioration of phase noise and other problems that result, as the mixer circuit 2g of the second tuner 2′ operates, from the impedance and other constants of the mixer circuit 2g varying and this variation influencing the voltage-controlled oscillation circuit 1f of the first tuner 1′. Here, the same benefits can be obtained by the use of, instead of a buffer amplifier (a buffer circuit with an application factor of 1 or more), a buffer circuit with an application factor less than 1.

Moreover, since the buffer amplifier 10 is a buffer circuit with an application factor of 1 or more, the local oscillation signal oscillated by the voltage-controlled oscillation circuit If of the first tuner 1′ can be fed to the second tuner 2′ with a stable level.

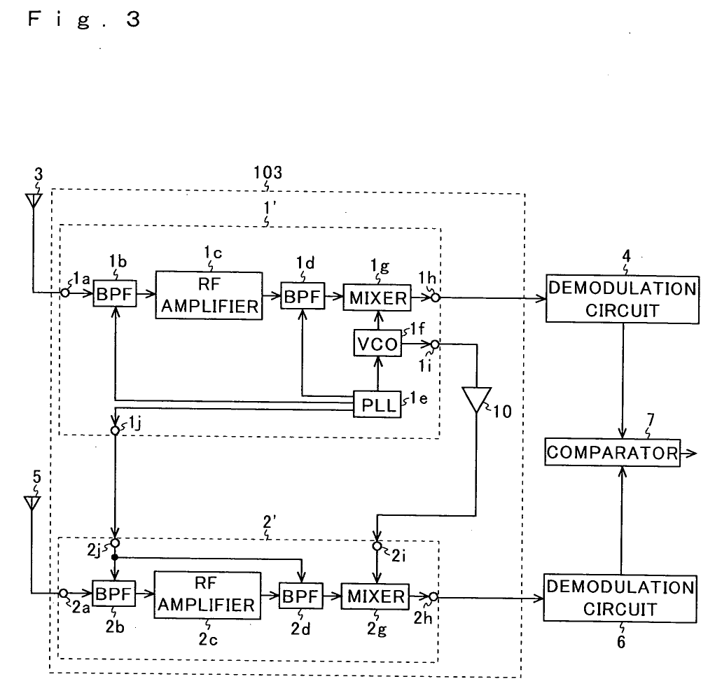

Next, a description will be given of the diversity reception tuner of a fourth embodiment of the invention. The configuration of the diversity reception tuner of the fourth embodiment of the invention is shown in FIG. 4. In FIG. 4, such circuit blocks as are found also in FIG. 1 are identified with the same reference numerals, and their detailed explanations will not be repeated.

The diversity reception tuner 104 of the fourth embodiment of the invention, as compared with the diversity reception tuner 100 of the first embodiment of the invention shown in FIG. 1, further includes a balloon coil 11 and a third tuner (not illustrated). The third tuner has the same configuration as the second tuner 2′.

The center tap of the balloon coil 11 is connected to the local oscillation signal output terminal 1i, one end of the balloon coil 11 is connected to the local oscillation signal input terminal 2i, and the other end of the balloon coil 11 is connected to a local oscillation signal input terminal provided in the third tuner.

With this configuration, it is possible to maintain isolation between the second tuner 2′ and the third tuner. This helps further reduce the interference between the second tuner 2′ and the third tuner. On the other hand, no isolation is produced between the first tuner 1′ and the second tuner 2′, nor between the first tuner 1′ and the third tuner. Thus, the local oscillation signal is fed from the first tuner 1′ to each of the second tuner 2′ and the third tuner. In a case where a diversity reception tuner according to the present invention is so configured as to include four or more tuners, it is advisable to increase the number of balloon coils to maintain isolation between the tuners other than the first tuner 1′. For example, in a case where a diversity reception tuner according to the present invention is so configured as to include four tuners, another balloon coil is added, and the other end of the balloon coil 11 is connected to the center tap of the added balloon coil so that the number into which the local oscillation signal is split is increased to three.

The first to fourth embodiments described above all deal with cases where both the first and second tuners are of the single-conversion type. It is, however, also possible to use as the first and second tuners double-conversion tuners or the like that need two or more local oscillation signals. In such cases, whereas the first tuner is provided with two or more voltage-controlled oscillation circuits, the second tuner is provided with none and instead receives from the first tuner the local oscillation signals oscillated by the voltage-controlled oscillation circuits provided therein.

The first to third embodiments described above all deal with cases where the diversity reception tuner is provided with two tuners. It is, however, also possible to provide a diversity reception tuner with three or more tuners. In such cases, only the first tuner is provided with a PLL circuit and a voltage-controlled oscillation circuit, and no other tuner is provided with either. The larger the number of tuners a diversity reception tuner is provided with, the greater the effect of cost reduction. Whereas in the first and second embodiments, the larger the number of tuners, the lower the level of the local oscillation signal distributed from the first tuner to every other tuner, in the third embodiment the provision of the buffer amplifier (a buffer circuit with an amplification factor of 1 or more) helps compensate for the lowering of the level of the local oscillation signal resulting from the distribution thereof.

The first to fourth embodiments described above all deal with cases where four tuning voltage output lines are extracted from the PLL circuit 1e. It is, however, also possible to extract only one tuning voltage output line from the PLL circuit 1e, and then branch it into four lines that are connected respectively to the band-pass filter 1b, band-pass filter 1d, voltage-controlled oscillation circuit 1f, and tuning voltage output terminal 1j. This helps shorten the total line length of the tuning voltage output lines laid in the first tuner, and thus helps make more compact the first tuner, and hence the diversity reception tuner as a whole.

By applying a diversity reception tuner according to the present invention to a diversity reception apparatus including a diversity reception tuner and a demodulator that generates a demodulated signal from the output signal of the diversity reception tuner, it is possible to realize an inexpensive diversity reception apparatus that can always receive the reception signal from whichever antenna offers optimum reception at the moment. In the first to fourth embodiments described above, each tuner is enclosed in a separate chassis so as to be electrically shielded. It is, instead, also possible to enclose each tuner along with a demodulation circuit and/or any other additional circuit connected thereto in a separate chassis to electrically shield them as a whole. In the first to fourth embodiments, instead of the demodulation circuit 4, demodulation circuit 6, and comparator 7, a demodulation circuit incorporating a comparator capability may be used. In this case, the demodulation circuit incorporating a comparator capability is configured as a circuit that receives the intermediate-frequency signals outputted respectively from the first and second tuners, then chooses whichever of those signals has higher quality, and then demodulates the chosen intermediate-frequency signal to produce and output a demodulated signal.

Furthermore, by applying a diversity reception apparatus according to the present invention to an electric appliance (for example, a television set or mobile telephone) having a diversity reception apparatus and an output apparatus that outputs images, sounds, and the like based on the output signal of the diversity reception apparatus, it is possible to realize an electric appliance that can output images, sounds, and the like with reduced noise and errors.

1. A diversity reception tuner comprising:
one first tuner; and
at least one tuner,
wherein said first tuner has a first PLL circuit and a first voltage-controlled oscillation circuit controlled by a tuning voltage generated by said first PLL circuit, said first tuner performing frequency conversion on a desired reception signal by using a local oscillation signal outputted from said first voltage-controlled oscillation circuit, and
wherein said tuner performs frequency conversion on the desired reception signal by using the local oscillation signal outputted from said first voltage-controlled oscillation circuit.

2. The diversity reception tuner of claim 1, further comprising:
at least one buffer circuit,
wherein the local oscillation signal outputted from said first voltage-controlled oscillation circuit is fed to said tuner via said buffer circuit.

3. The diversity reception tuner of claim 1, further comprising:
at least two tuners as said tuner; and
at least one balloon coil,
wherein the local oscillation signal outputted from said first voltage-controlled oscillation circuit is fed to said tuners via said balloon coil, said balloon coil producing isolation between said tuners.

4. The diversity reception tuner of claim 1,
wherein said first tuner is mounted on an IC chip, and said at least one tuner is each mounted on a separate IC chip.

5. The diversity reception tuner of claim 1,
wherein said first tuner and said tuner each have a selector for selecting the desired reception signal from reception signals, and
wherein at least one of filters provided in said selector has a filtering characteristic thereof controlled by the tuning voltage generated by said first PLL circuit.

6. The diversity reception tuner of claim 1,
wherein said first tuner and said tuner are each enclosed in a separate chassis so as to be electrically shielded.

7. A diversity reception tuner comprising:
one first tuner; and
at least one tuner,
wherein said first tuner has a first PLL circuit and a first voltage-controlled oscillation circuit controlled by a tuning voltage generated by said first PLL circuit, said first tuner performing frequency conversion on a desired reception signal by using a local oscillation signal outputted from said first voltage-controlled oscillation circuit, and
wherein said tuner has a voltage-controlled oscillation circuit controlled by the tuning voltage generated by said first PLL circuit, said tuner performing frequency conversion on the desired reception signal by using a local oscillation signal outputted from said voltage-controlled oscillation circuit.

8. The diversity reception tuner of claim 7,
wherein said first tuner is mounted on an IC chip, and said at least one tuner is each mounted on a separate IC chip.

9. The diversity reception tuner of claim 7,
wherein said first tuner and said tuner each have a selector for selecting the desired reception signal from reception signals, and
wherein at least one of filters provided in said selector has a filtering characteristic thereof controlled by the tuning voltage generated by said first PLL circuit.

10. The diversity reception tuner of claim 7,
wherein said first tuner and said tuner are each enclosed in a separate chassis so as to be electrically shielded.

11. A diversity reception apparatus comprising:
a diversity reception tuner,
wherein said diversity reception tuner comprises one first tuner and at least one tuner,
wherein said first tuner has a first PLL circuit and a first voltage-controlled oscillation circuit controlled by a tuning voltage generated by said first PLL circuit, said first tuner performing frequency conversion on a desired reception signal by using a local oscillation signal outputted from said first voltage-controlled oscillation circuit, and
wherein said tuner performs frequency conversion on the desired reception signal by using the local oscillation signal outputted from said first voltage-controlled oscillation circuit.

12. The diversity reception apparatus of claim 11,
wherein said diversity reception tuner further comprises at least one buffer circuit, and
wherein the local oscillation signal outputted from said first voltage-controlled oscillation circuit is fed to said tuner via said buffer circuit.

13. The diversity reception apparatus of claim 11,
wherein said diversity reception tuner further comprises at least two tuners as said tuner and at least one balloon coil,
wherein the local oscillation signal outputted from said first voltage-controlled oscillation circuit is fed to said tuners via said balloon coil, said balloon coil producing isolation between said tuners.

14. The diversity reception apparatus of claim 11,
wherein said first tuner is mounted on an IC chip, and said at least one tuner is each mounted on a separate IC chip.

15. The diversity reception apparatus of claim 11,
wherein said first tuner and said tuner each have a selector for selecting the desired reception signal from reception signals, and
wherein at least one of filters provided in said selector has a filtering characteristic thereof controlled by the tuning voltage generated by said first PLL circuit.

16. The diversity reception apparatus of claim 11,
wherein said first tuner and said tuner are each enclosed in a separate chassis so as to be electrically shielded.

17. A diversity reception apparatus comprising:
a diversity reception tuner,
wherein said diversity reception tuner comprises one first tuner and at least one tuner,
wherein said first tuner has a first PLL circuit and a first voltage-controlled oscillation circuit controlled by a tuning voltage generated by said first PLL circuit, said first tuner performing frequency conversion on a desired reception signal by using a local oscillation signal outputted from said first voltage-controlled oscillation circuit, and
wherein said tuner has a voltage-controlled oscillation circuit controlled by the tuning voltage generated by said first PLL circuit, said tuner performing frequency conversion on the desired reception signal by using a local oscillation signal outputted from said voltage-controlled oscillation circuit.

18. The diversity reception apparatus of claim 17,
wherein said first tuner is mounted on an IC chip, and said at least one tuner is each mounted on a separate IC chip.

19. The diversity reception apparatus of claim 17,
wherein said first tuner and said tuner each have a selector for selecting the desired reception signal from reception signals, and
wherein at least one of filters provided in said selector has a filtering characteristic thereof controlled by the tuning voltage generated by said first PLL circuit.

20. The diversity reception apparatus of claim 17,
wherein said first tuner and said tuner are each enclosed in a separate chassis so as to be electrically shielded.

21. An electric appliance comprising:
a diversity reception apparatus,
wherein said diversity reception apparatus comprises a diversity reception tuner,
wherein said diversity reception tuner comprises one first tuner and at least one tuner,
wherein said first tuner has a first PLL circuit and a first voltage-controlled oscillation circuit controlled by a tuning voltage generated by said first PLL circuit, said first tuner performing frequency conversion on a desired reception signal by using a local oscillation signal outputted from said first voltage-controlled oscillation circuit, and
wherein said tuner performs frequency conversion on the desired reception signal by using the local oscillation signal outputted from said first voltage-controlled oscillation circuit.

22. The electric appliance of claim 21,
wherein said diversity reception tuner further comprises at least one buffer circuit, and
wherein the local oscillation signal outputted from said first voltage-controlled oscillation circuit is fed to said tuner via said buffer circuit.

23. The electric appliance of claim 21,
wherein said diversity reception tuner further comprises at least two tuners as said tuner and at least one balloon coil,
wherein the local oscillation signal outputted from said first voltage-controlled oscillation circuit is fed to said tuners via said balloon coil, said balloon coil producing isolation between said tuners.

24. The electric appliance of claim 21,
wherein said first tuner is mounted on an IC chip, and said at least one tuner is each mounted on a separate IC chip.

25. The electric appliance of claim 21,
wherein said first tuner and said tuner each have a selector for selecting the desired reception signal from reception signals, and
wherein at least one of filters provided in said selector has a filtering characteristic thereof controlled by the tuning voltage generated by said first PLL circuit.

26. The electric appliance of claim 21,
wherein said first tuner and said tuner are each enclosed in a separate chassis so as to be electrically shielded.

27. An electric appliance comprising:
a diversity reception apparatus,
wherein said diversity reception apparatus comprises a diversity reception tuner,
wherein said diversity reception tuner comprises one first tuner and at least one tuner,
wherein said first tuner has a first PLL circuit and a first voltage-controlled oscillation circuit controlled by a tuning voltage generated by said first PLL circuit, said first tuner performing frequency conversion on a desired reception signal by using a local oscillation signal outputted from said first voltage-controlled oscillation circuit, and
wherein said tuner has a voltage-controlled oscillation circuit controlled by the tuning voltage generated by said first PLL circuit, said tuner performing frequency conversion on the desired reception signal by using a local oscillation signal outputted from said voltage-controlled oscillation circuit.

28. The electric appliance of claim 27,
wherein said first tuner is mounted on an IC chip, and said at least one tuner is each mounted on a separate IC chip.

29. The electric appliance of claim 27,
wherein said first tuner and said tuner each have a selector for selecting the desired reception signal from reception signals, and
wherein at least one of filters provided in said selector has a filtering characteristic thereof controlled by the tuning voltage generated by said first PLL circuit.

30. The electric appliance of claim 27,
wherein said first tuner and said tuner are each enclosed in a separate chassis so as to be electrically shielded.
